(19) United States
(12) Patent Application Publication
(10) Pub. No.: US 2012/0147610 A1
(43) Pub. Date: Jun. 14, 2012

(54) DEVICE FOR MOUNTING A STRIP OF LIGHT EMITTING DIODES

(75) Inventor: Kaj Ransvi, Vellinge (SE)

(73) Assignee: MULTILIST SWEDEN AB, Vellinge (SE)

(21) Appl. No.: 13/312,035

(22) Filed: Dec. 6, 2011

(30) Foreign Application Priority Data
Dec. 10, 2010 (EP) 10194540.0

(51) Int. Cl. F21V 21/00

(52) U.S. Cl. 362/382

(57) ABSTRACT

A device (10) for mounting a strip (11) of light emitting diodes, comprising a first portion (12) and a second portion (13) arranged substantially perpendicular to the first portion (12), the first portion (12) having a first side (18) and an opposite second side (19), wherein the second side (19) of the first portion (12) is provided with a flexible first projection (22), and the second portion (13) having a first side (20) and an opposite second side (21), wherein the second side (21) of the second portion (13) is provided with a second projection (23), the first and second portions (12, 13) and the first and second projections (22, 23) forming a space (24) for receiving the strip (11), wherein the first and second projections (22, 23) are arranged for engaging the strip (11) to retain the strip (11) in the space (24).

### CROSS-REFERENCE TO RELATED APPLICATIONS

This application claims the benefit of priority from European Patent Application No. 10194540.0 filed on Dec. 10, 2010, the contents of which are incorporated herein by reference in its entirety.

### TECHNICAL FIELD

The invention relates to a device for mounting a strip of light emitting diodes. A strip of light emitting diodes, also known as an LED strip, can be used as lighting in a plurality of applications. For example, LED strips can be used as lighting in domestic areas as well as in industrial or commercial areas. For example, LED strips can be mounted in ceilings, shelves, cupboards, etc., to provide lighting. LED strips can comprise a cover of silicone or similar material.

### SUMMARY

One object of the present invention is to provide a device for mounting a strip of light emitting diodes according to claim 1. The device for mounting a strip of light emitting diodes can comprise a first portion and a second portion arranged substantially perpendicular to the first portion, the first portion having a first side and an opposite second side, wherein the second side of the first portion is provided with a flexible first projection, and the second portion having a first side and an opposite second side, wherein the second side of the second portion is provided with a second projection, the first and second portions and the first and second projections forming a space for receiving the strip, wherein the first and second projections are arranged for engaging the strip to retain the strip in the space. The device can be attached to a surface, for example by means of an adhesive, adhesive tape or by conventional mechanical fasteners to enable easy and reliable mounting of the strip of light emitting diodes to the surface. The strip of light emitting diodes can be arranged in the space of the device before or after fastening of the device to the surface.

The first projection can be provided with a protrusion for engaging a light emitting side of the strip. For example, the protrusion extends towards the second projection or at least the second portion, wherein the light emitting side of the strip is supported by the protrusion and the second projection. Hence, the protrusion and the second projection can prevent the strip from leaving the device unintentionally.

The first projection can be resiliently flexible, so that the first projection can be displaced to facilitate insertion of the strip into the space and then returned to retain the strip inside the space. Also the second projection can be resiliently flexible.

The first and/or the second projection can be inclined inwards and can be biased towards its inclined position to clamp the LED strip in the space. By the inclined structure of the first and/or second projection the LED strip is held more firmly and efficiently in the space and provides possibilities to mount LED strips of different sizes therein. The inclined structure of the first and/or the second projection can facilitate mounting of the LED strip.

The first portion and the second portion can form an uninterrupted elongated mounting strip having substantially L-shaped cross section provided with the projections. Optionally, the projections can extend continuously along the first and second portions, respectively, wherein the projections support the strip continuously. Optionally, the protrusion can extend continuously along the first projection, wherein the protrusion supports the strip continuously to prevent the strip from hanging down.

The second projection can be arranged a distance from a free end of the second portion, so that the second portion extends beyond the second projection to form a screen for screening off the strip of light emitting diodes. The second portion can extend a distance from the second projection to reduce the direct visibility of the strip.

The first projection can be arranged a distance from a free end of the first portion, for example, to facilitate fastening of the device to a surface.

The second portion can be provided with a notch between the second projection and a free end of the second portion, wherein the second portion is breakable along said notch. Then, if the extended part of the second portion not is required or desirable it can be removed.

Disclosed is also a method for mounting a strip of light emitting diodes. The method can comprise the steps of

arranging a portion of the strip of light emitting diodes in a space of a strip holding device according to the invention,

arranging the strip of light emitting diodes in contact with the second projection inside said space,

displacing the flexible first projection away from the second portion, arranging the strip of light emitting diodes in the space, and bringing the first projection in contact with the strip of light emitting diodes.

The method can also comprise the step of bringing a protrusion of the first projection to engage a light emitting side of the strip of light emitting diodes.

Further characteristics and advantages of the present invention will become apparent from the description of the embodiments below, the appended drawings and the dependent claims.

### SHORT DESCRIPTION OF THE DRAWINGS

Non-limiting examples of the device for mounting a strip of light emitting diodes according to this disclosure will now be described in more detail with reference to the appended drawings, in which:

FIG. 1 is a schematic side view of a device for mounting a strip of light emitting diodes according to one embodiment,

FIG. 2 is a schematic side view of the device according to FIG. 1 provided with a strip of light emitting diodes,

FIG. 3 is a schematic perspective view of the device according to FIG. 1,

FIG. 4 is a schematic perspective view of the device according to FIG. 1,

FIG. 5 is a schematic side view of the device according to FIG. 1, holding a strip of light emitting diodes and being mounted on a surface in the form of a ceiling,

FIG. 6 is a schematic side view of the device according to FIG. 1, holding a strip of light emitting diodes and being mounted on a surface under a shelf,

FIG. 7 is a schematic side view of the device according to FIG. 1, holding a strip of light emitting diodes and being mounted on a surface on top of a shelf,

FIG. 8 is a schematic side view of the device according to FIG. 1, holding a strip of light emitting diodes and being mounted on a surface under a shelf,

FIG. 9 is a schematic side view of a device for mounting a strip of light emitting diodes according to one alternative embodiment,

FIG. 10 is a schematic side view of a device for mounting a strip of light emitting diodes according to another alternative embodiment,

FIGS. 11 and 12 are schematic side views illustrating the mounting of a strip of light emitting diodes in a device according to FIG. 1,

FIG. 13 is a schematic side view of a device for mounting a strip of light emitting diodes according to another embodiment,

FIG. 14 is a schematic perspective view of the device according to FIG. 13, and

FIG. 15 is a schematic perspective view of the device according to FIG. 13.

### DESCRIPTION OF EXAMPLES

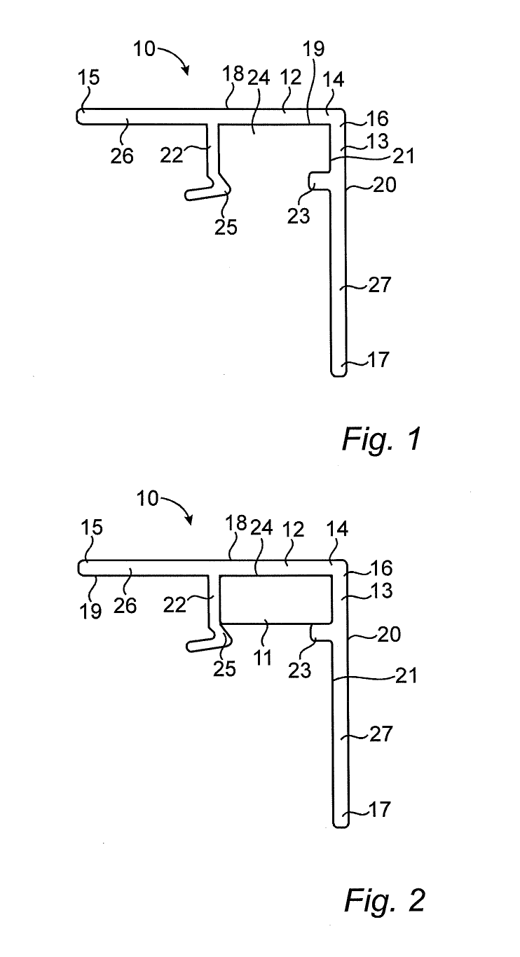

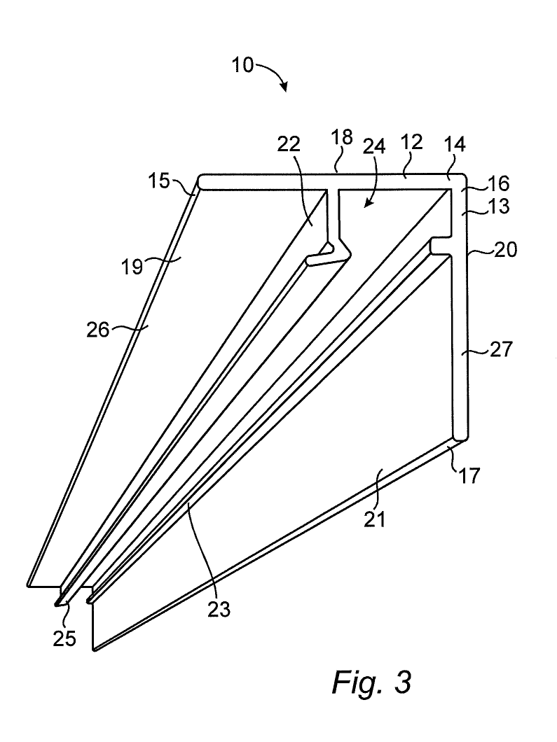

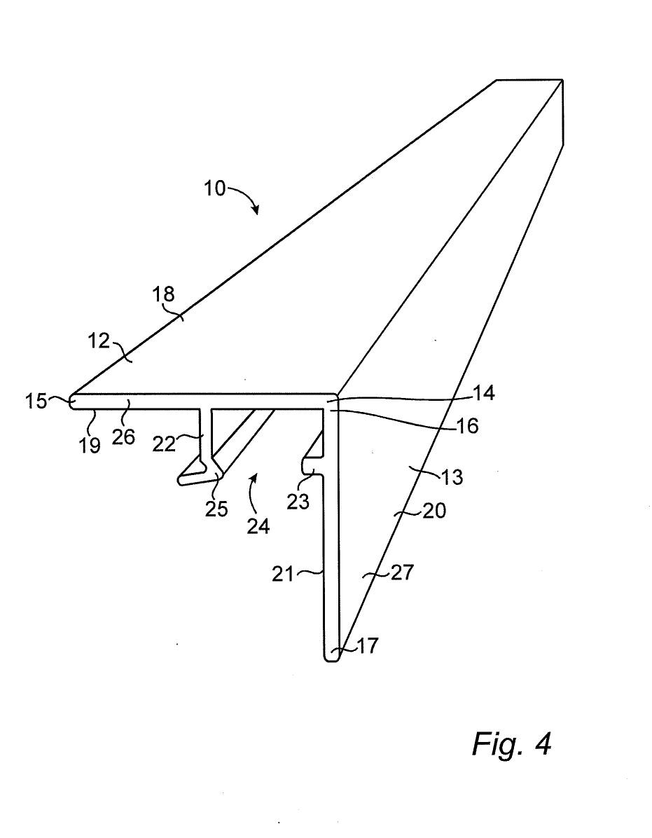

With reference to FIGS. 1-4 a device 10 for mounting a strip 11 of light emitting diodes, which also is known as an LED strip, according to one embodiment example is illustrated. The device 10 is illustrated without the strip 11 in FIGS. 1, 3 and 4 and with the strip 11 in FIG. 2. The device 10 is arranged as a mounting strip for holding the LED strip 11. Hence, the device 10 can be elongated and can be arranged in any suitable length. For example, the device 10 can be cut into the desired length. For example, the device 10 is a mounting strip of plastic materials, such as flexible plastic materials and according to one embodiment the device 10 is entirely made of plastic materials. For example, the device 10 is not an armature and does not include any electrical connections, cables or similar as conventional LED strips 11 indude light sources as well as the required connections, cables and similar. For example, the device 10 is formed so that the LED strip 11 can be mounted in the device 10 and attached to the device 10 without any conventional fasteners such as screws, a cover glass or similar.

The device 10 according to the drawings comprises a first portion 12 and a second portion 13 connected to the first portion 12. For example, the first and second portions 12, 13 are elongated and are, for example, formed as strips. The second portion 13 is arranged substantially perpendicular to the first portion 12. The first portion 12 has a first end 14 and a second end 15, wherein the second portion 13 has a first end 16 and a second end 17. According to the drawings, the first end 14 of the first portion 12 is connected to the first end 16 of the second portion 13 forming a substantially L-shaped cross section. According to the drawings, the second end 15 of the first portion 12 and the second end 17 of the second portion 13 are free ends. The first and second portions 12, 13 are, for example, made of a rigid or flexible material, such as a suitable polymer material, rubber, metal or wood. For example, the first and second portions 12, 13 are made of polycarbonate or a material having similar properties.

The first portion 12 has a first side 18 and an opposite second side 19. Also the second portion has a first side 20 and an opposite second side 21. For example, the first side 18 of the first portion 12 is arranged for engaging a surface, which is described more in detail below.

The second side 19 of the first portion 12 is provided with a first projection 22, wherein the second side 21 of the second portion 13 is provided with a second projection 23. According to e.g. FIG. 1, the first projection 22 projects substantially perpendicular from the first portion 12 and substantially in parallel with the second portion 13, wherein the second projection 23 projects substantially perpendicular from the second portion 13 and substantially in parallel with the first portion 12. For example, the second projection 23 extends towards the first projection 22. Alternatively, the first and/or second projections 22, 23 are inclined, which is described more in detail below.

The first projection 22 is arranged a distance from the first end 14 of the first portion 12, wherein the second projection 23 is arranged a distance from the first end 16 of the second portion 13, the first and second portions 12, 13 and the first and second projections 22, 23 forming a space 24 for receiving the strip 11. Hence, the first and second projections 22, 23 are arranged for engaging the strip 11 to retain the strip 11 in the space 24. For example, the space 24 is arranged with a substantially rectangular cross section. Alternatively, the space 24 is arranged with another cross section shape, such as a polygonal or rounded shape.

The first projection 22 is flexible, so that it can be displaced, for example rotated or bent away, in a direction away from the second portion 13 and the second projection 23 to facilitate insertion of the strip 11 into the space 24, which will be described in more detail below. For example, the first projection 22 is resiliently flexible so as to return to its original position when a displacing force upon it ceases. The second projection 23 can be rigid or flexible, such as resiliently flexible. According to the illustrated embodiments, the first projection 22 is longer than the second projection 23. For example, the first projection 22 comprises a resilient material or a resilient device. The first projection 22 is, for example, made of a resilient material or is connected to the first portion 12 by means of a resilient material or device. One example of a resilient device is a conventional spring. Hence, the first and second projections 22, 23 are arranged for engaging the strip 11 to retain the strip 11 in the space 24 without the need for any further fasteners or a cover glass or similar to hold the strip 11 in the space 24.

For example, the first and second projections 22, 23 are continuous, i.e. uninterrupted, and extend along the length of the first and second portions 12, 13, respectively. Hence, the first and second projections 22, 23 may engage the strip 11 along substantially the entire length of the strip 11 supported by the device 10. Alternatively, the first and second projections 22, 23 are interrupted, so that a plurality of projections 22, 23 is distributed along the first and second portions 12, 13, respectively, at suitable intervals.

The first projection 22 is provided with a protrusion 25, so that the strip 11 is partially enclosed when arranged in the space 24. The protrusion 25 extends in a direction towards the second portion 13 and the second projection 23, so that the protrusion 25 and the second projection 23 engage the same side of the strip 11 when the strip 11 is arranged in the space 24. For example, the protrusion 25 and the second projection 23 engage a visible or light emitting side of the strip 11 when the strip 11 is arranged in the space 24. According to one example, the remaining sides of the strip 11 is hidden or at least partially hidden, by the first projection 22, the first portion 12 and the second portion 13. In FIG. 1, the protrusion 25 is formed by a portion of the first projection 22 angled towards the second portion 13. For example, the protrusion 25 is formed by a U-turn or V-shaped portion of the first projection 22. For example, the first projection 22 is terminated with the protrusion 25. Alternatively, the first projection 22 is made of or provided with a material having high friction against the strip 11, so as to retain the strip 11 in the space 24 instead of the protrusion 25 illustrated in the drawings.

For example, the protrusion 25 extends continuously, i.e. uninterrupted, along substantially the entire length of the first projection 12, wherein the strip 11 arranged in the space 24 is supported by the protrusion 25 substantially along its entire length. Support of the strip 11 along substantially its entire length can result in that the strip 11 is held more firmly in position in the space 24, which may prevent the strip from hanging down. Alternatively, the protrusion 25 is interrupted, so that a plurality of protrusions 25 is distributed along the first projection 22 at a suitable interval.

The first portion 12 optionally extends beyond the first projection 22, forming a first extended part 26 between the first projection 22 and the second end 15 of the first portion 12. The second portion 13 optionally extends beyond the second projection 23, forming a second extended part 27 between the second projection 23 and the second end 17 of the second portion 13. Optionally, the first extended part 26 is arranged with a length or width substantially corresponding to the length or width of the second extended part 27.

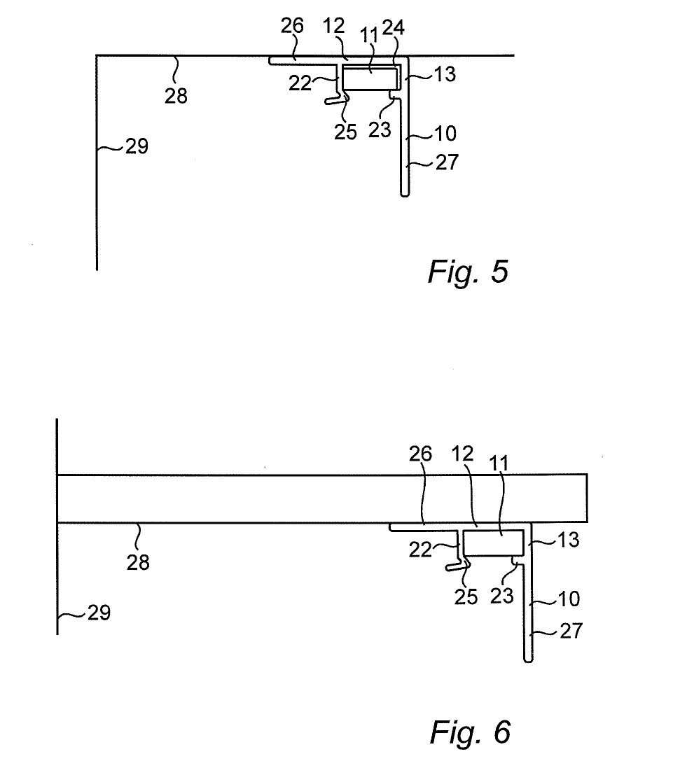

With reference to FIGS. 5-8 the device 10 holding the strip 11 is mounted in various positions to illustrate a few possible examples of mounting positions and applications. In FIG. 5 the strip 11 is arranged in the space 24 of the device 10, wherein the device 10 has been arranged on a surface 28 formed by a ceiling. Optionally, the device 10 is arranged close to a wall 29 or similar, i.e. with a relatively small distance to the wall 29. In FIG. 5, the first side 18 of the first portion 12 is attached to the surface 28. Hence, the first portion 12 is arranged in parallel to the surface 28, wherein the second portion 13 projects substantially perpendicular from the surface 28. For example, the first side 18 of the first portion 12 is provided with a fastener for attachment to the surface 28. For example the fastener is an adhesive, adhesive tape or similar for fastening the device 10 to the surface 28. Alternatively, the device 10 is fastened to the surface 28 by means of conventional mechanical fasteners, such as screws, nails, fittings, hooks, strings, hook and loop fasteners or any other suitable conventional fastener. For example, the first extended part 26 of the first portion 12 can form an enlarged contact surface between the device 10 and the surface 28 on which the device 10 is to be mounted. Alternatively, the extended part 26 can form an area suitable for mechanical fasteners.

In FIG. 5, the second extended part 27 of the second portion 13 can form a screen for screening off the strip 11, so that the strip 11 is less visible. For example, the second extended part 27 is arranged so that the light emitting side of the strip 11 not easily is directly visible. The second side 21 of the second portion 13 can comprise a light reflecting surface.

In FIG. 6, the device 10 is mounted on a surface 28 under a shelf or similar. The device 10 is holding a strip 11 of light emitting diodes. Of course, the device 10 can be mounted in a similar manner on a surface 28 under a wall cupboard or any other suitable surface 28. In FIG. 6, the device 10 is arranged in an area close to a free end of the surface 28 and a distance from the wall 27, wherein the first portion 12 is arranged in contact with the surface 28 and the second extended part 27 of the second portion 13 extends from the surface 28 to form a screen screening off the strip 11, so that the strip 11 is less visible or not easily directly visible. For example, the first portion 12 is provided with a fastener for connecting the device 10 to the surface 28.

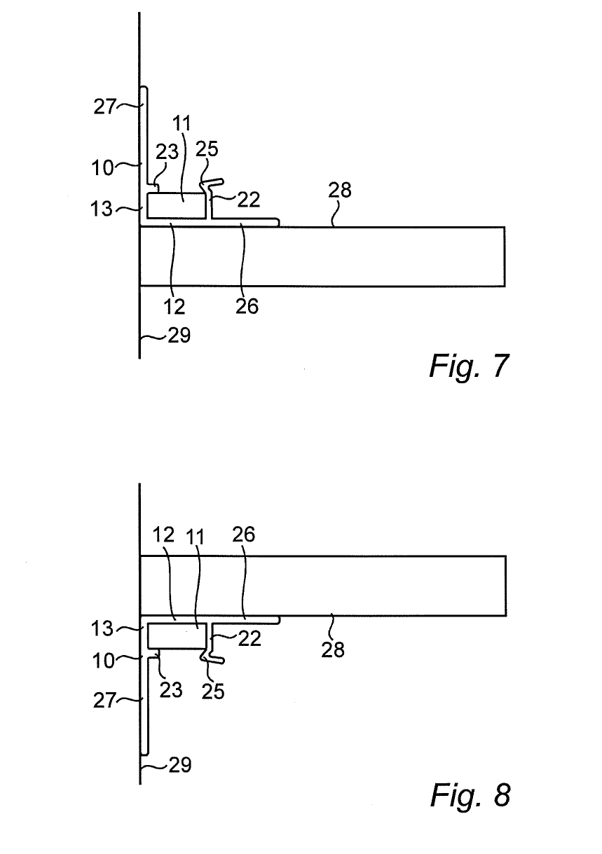

In FIG. 7, a strip 11 arranged in a device 10 is illustrated, wherein the device 10 is mounted on a surface 28 on the top of a shelf or similar. In FIG. 7, the first portion 12 is arranged in contact with the surface 28, wherein the second portion 13 is engaging the wall 29 or similar. Hence, according to FIG. 7 the second extended part 27 of the second portion 13 is not used as a screen. For example, the second part 13 is fastened to the wall 29. Hence, the second part 13 can optionally be provided with fasteners, adhesive, adhesive tape or similar in a corresponding manner as the first portion 12. Hence, the first portion 12 and/or the second portion 13 can be provided with the fastener for connecting the device 10 to the surface 28.

With reference to FIG. 8, the device 10 carrying the strip 11 is arranged on a surface 28 under a shelf or similar. In FIG. 8, the first portion 12 is arranged in contact with the surface 28, wherein the second portion 13 is arranged in contact with the wall 29. For example, the first portion 12 and/or the second portion 13 is provided with the fastener for connecting the device 10 to the surface 28.

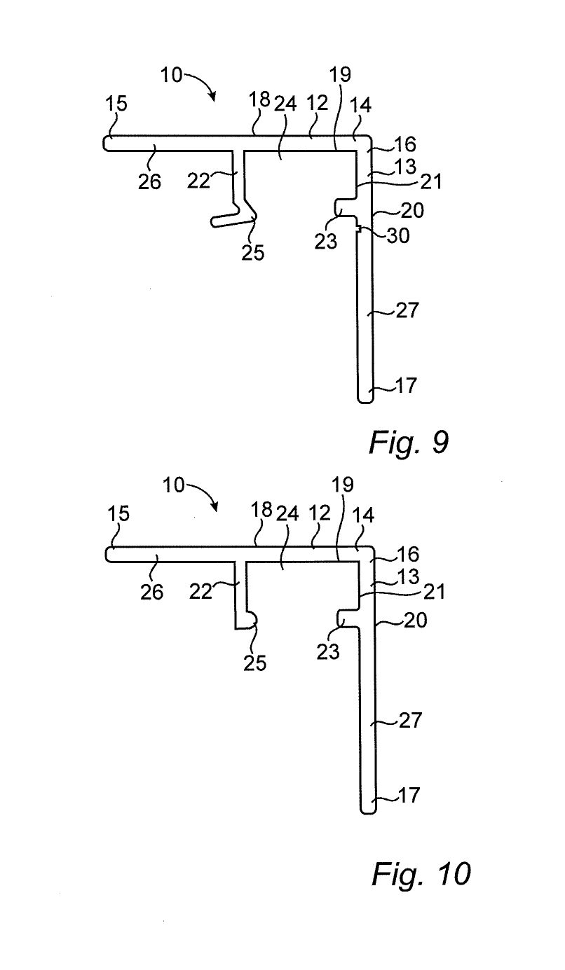

With reference to FIG. 9 one embodiment example of the device 10 according to this disclosure is illustrated. According to FIG. 9 the second portion 13 is provided with a notch 30, so that the second portion 13 is breakable along the notch 30. The notch 30 is arranged between the second projection 23 and the free second end 17 of the second portion 13. The notch 30 is provided to facilitate removal of substantially the second extended part 27 of the second portion 13 if desired. Hence, the notch 30 can be provided close to or adjacent the second projection 23.

With reference to FIG. 10 another embodiment example of the device 10 according to this disclosure is illustrated. According to FIG. 10 the protrusion 25 on the first projection 22 is arranged as a rounded part extending from the first projection 22. For example, the protrusion 25 in the form of the rounded part extends towards the second portion 13 and the second projection 23. For example, the rounded part extends perpendicular or substantially perpendicular from the first projection 22. For example, the protrusion 25 is arranged at the free end of the first projection 22, wherein the first projection 22 is terminated with the protrusion 25. Alternatively, the protrusion 25 is provided with edges or is bevelled.

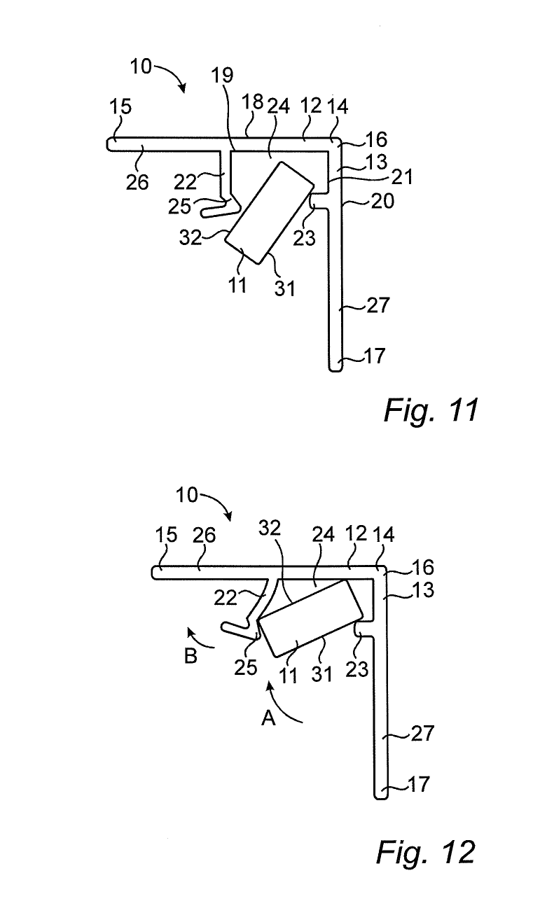

In FIGS. 11 and 12 one example of the mounting of the strip 11 in the device 10 is illustrated. In FIG. 11 the device 10 is in a default or resting position, wherein no force is applied to the first projection 12 or the protrusion 22. With reference to FIG. 11 a portion of the strip 11 is inserted between the first and second projections 22, 23 and into the space 24, wherein the strip 11 is inclined in relation to the space 24. A light emitting side 31, i.e. a main light emitting side, front side or visible side, of the strip 11 is brought into contact with the second projection 23. Then, the strip 11 is pushed towards the flexible first projection 22 or the protrusion 25 in a direction illustrated by means of arrow A in FIG. 12, so that the first projection 22 is displaced in a direction illustrated by means of arrow B. Hence, the first projection 22 is displaced away from the second projection 23 so as to enlarge the distance between the protrusion 25 and the second projection 23 to facilitate insertion of the strip 11 into the space 24. For example, the free end of the first projection 22 is displaced towards the second end 15 of the first portion 12. For example, the first projection 22 is bent or rotated away from the second projection 23. When the strip 11 is pushed further into the space 24, the first projection 22 returns to its original position by means of its resilient properties, wherein the protrusion 25 and the second projection 23 supports the light emitting side 31 of the strip 11 to retain the strip 11 inside the space 24, as illustrated in FIG. 2. Hence, when mounted in the device 10 according to the drawings, the strip 11 engages at least the protrusion 25 and the second projection 23. The light emitting side 31 of the strip 11 engages the protrusion 25 and the second projection 23. For example, the opposite side 32 of the strip 11, i.e. the side opposite the light emitting side 31, is facing the first portion 12.

Of course, the first projection 22 can be displaced by the fingers of a person, while the strip 11 is fitted into the space. It is also to be understood that the strip 11 can be arranged in the space in other ways. For example, in an embodiment example in which the second projection 23 is flexible, the second projection 23 can be displaced in addition to or instead of the first projection 22. It is also to be understood that the strip 11 initially can be brought into contact with the first projection 22 and then into contact with the second projection 23.

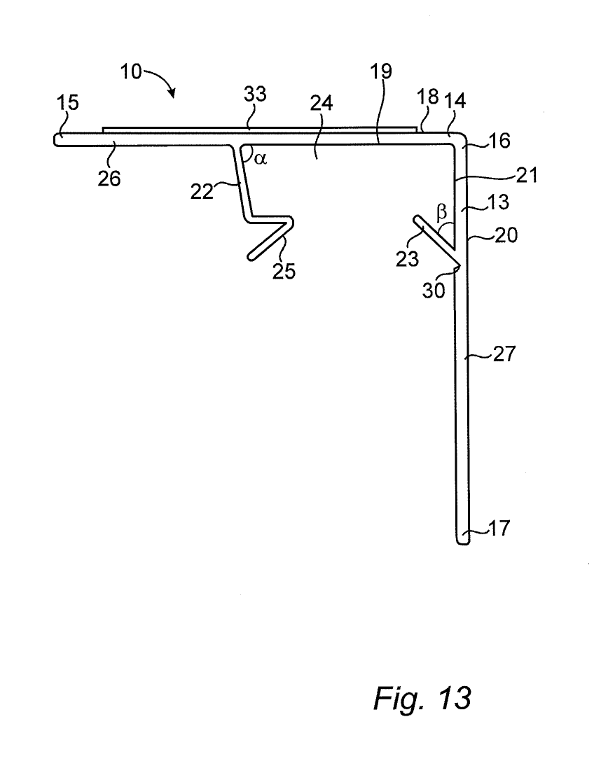

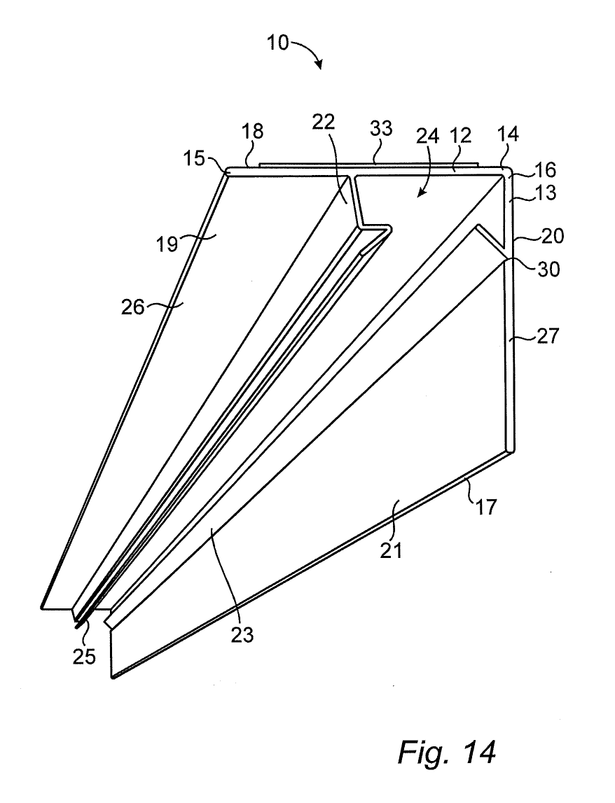

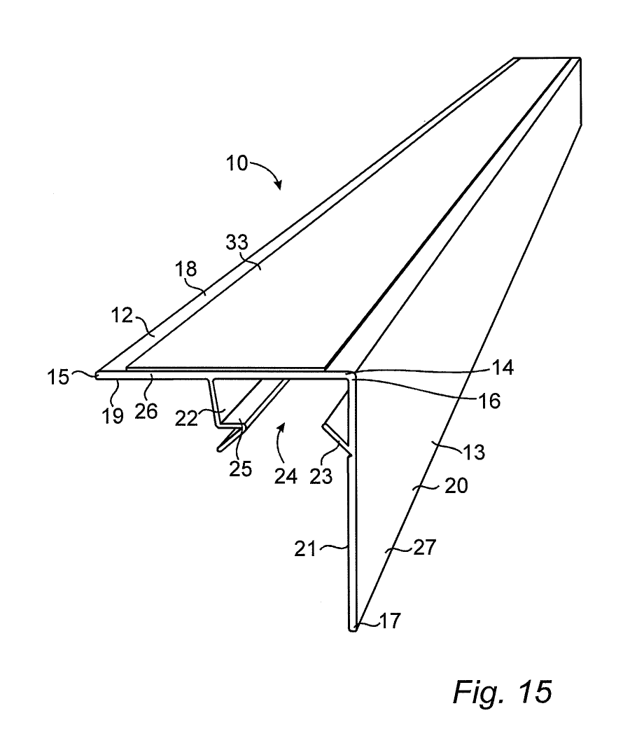

With reference to FIGS. 13-15 another embodiment example of the device 10 according to this disclosure is illustrated. According to the embodiment of FIGS. 13-15 the first projection 22 is inclined towards the second portion 13, wherein the first projection 22 is arranged with an angle α to the first portion 12. The angle α is arranged between the first projection 22 and the second side 19 of the first portion 12 in a direction towards the first end 14 of the first portion 12. For example, the angle α is less than 90°, and for example, 60-85° or about 80°.

For example, the first projection 22 is resiliently flexible and can be displaced away from the second portion 13 as described above, so that a LED strip 11 can be positioned in the space 24 and be held in place in said space 24 by the first projection 22. Hence, the first projection 22 is biased towards its inclined position due to its inherent resiliently flexible properties, wherein the first projection 22 can be bent away so as to increase the distance between the first and second projections 22, 23 and make room for the strip 11 and then provide a retaining force against the LED strip 11 when mounted in the space 24. Hence, when mounted in the space 24, the strip 11 is clamped between the first projection 22 and the second portion 13. According to the embodiment of FIGS. 13-15 the first projection 22 is formed with the protrusion 25 for engaging the light emitting side 31 of the strip 11, which protrusion 25 also can be flexible.

In the embodiment of FIGS. 13-15 the second projection 23 is inclined towards the first portion 12, wherein the second projection 23 is arranged with an angle β to the second portion 13. The angle β is arranged between the second projection 23 and the second side 21 of the second portion 13 in a direction towards the first end 16 of the second portion 13. For example, the angle β is less than 90°, and for example, 30-80°, 40-60° or about 45°.

For example, the second projection 23 is resiliently flexible and can be displaced away from the first portion 12, so that the LED strip 11 can be positioned in the space 24 and be held in place in said space 24 by the first and second projections 22, 23. Hence, the second projection 23 is biased towards its inclined position due to its inherent resiliently flexible properties, wherein the second projection 23 can be bent away so as to increase the distance between the first and second projections 22, 23 and make room for the strip 11 and then provide a retaining force against the LED strip 11 when mounted in the space 24. Hence, when mounted in the space 24, the strip 11 is clamped between the second projection 23 and the first portion 12. The second projection 23 is arranged for engaging the light emitting side 31 of the strip 11. The first projection 22 is, for example, longer than the second projection 23.

In the embodiment of FIGS. 13-15 the first portion 12 is provided with an optional adhesive tape 33 for fastening the device 10 to the surface 28. For example, the adhesive tape 33 is a continuous tape arranged along substantially the entire length of the first portion 12.

According to one embodiment, the first portion 12 is flexible so as to be more easily shaped or adapted to the surface 28. For example, the first portion 12 is thinner and/or more flexible than the second portion 13, wherein the first portion 12 is adaptable to the mounting surface 28 while the second portion 13 provides favorable light screening properties.

1. A device for mounting a strip of light emitting diodes, comprising a first portion and a second portion arranged substantially perpendicular to the first portion, the first portion having a first side and an opposite second side, wherein the second side of the first portion is provided with a flexible first projection, and the second portion having a first side and an opposite second side, wherein the second side of the second portion is provided with a second projection, the first and second portions and the first and second projections forming a space for receiving the strip, wherein the first and second projections are arranged for engaging the strip to retain the strip in the space.

2. A device according to claim 1, wherein the first projection is provided with a protrusion extending towards the second portion.

3. A device according to claim 2, wherein the first projection is resiliently flexible.

4. A device according to claim 3, wherein the first projection is inclined towards the second portion and is biased to its inclined position by its resiliently flexible properties.

5. A device according to claim 4, wherein an angle between the first projection and the first portion is about 60-85°.

6. A device according to claim 5, wherein the angle is about 80°

7. A device according to claim 1, wherein the second projection is resiliently flexible.

8. A device according to claim 7, wherein the second projection is inclined towards the first portion and is biased to its inclined position by its resiliently flexible properties.

9. A device according to claim 8, wherein an angle between the second projection and the second portion is about 30-80°.

10. A device according to claim 9, wherein the angle between the second projection and the second portion is about 40-60°.

11. A device according to claim 10, wherein the angle between the second projection and the second portion is about 45°.

12. A device according to claim 1, wherein the first portion and the second portion form an uninterrupted elongated mounting strip having substantially L-shaped cross section provided with the projections.

13. A device according to claim 1, wherein the first side of the first portion is provided with an adhesive tape for fastening the device to a surface.

14. A device according to claim 1, wherein the second projection is arranged a distance from a free end of the second portion, so that the second portion extends beyond the second projection to form a screen for screening off the strip of light emitting diodes.

15. A device according to claim 1, wherein the first projection is arranged a distance from a free end of the first portion.

16. A device according to claim 1, wherein the second portion is provided with a notch between the second projection and a free end of the second portion, and wherein the second portion is breakable along said notch.
